(19) United States
(12) Patent Application Publication
(10) Pub. No.: US 2010/0185687 A1
(43) Pub. Date: Jul. 22, 2010

(54) SELECTING ADVERTISEMENTS

(75) Inventors: WOOK JIN CHUNG, KIRKLAND, WA (US); JODY DAVID BIGGS, REDMOND, WA (US); MICHAEL LEE LORITSCH, REDMOND, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/353,274

(22) Filed: Jan. 14, 2009

(51) Int. Cl. G06F 17/30

(52) U.S. Cl. 707/803; 707/E17.074; 705/14.68

(57) ABSTRACT

An advertisement management system, a computer-implemented method, and computer readable media to select advertisements are provided. The advertisement management system includes a keyword component, a targeting component, and a merging component. The keyword component generates a lists of advertisements based on keywords provided by the advertisers. The targeting component, executing in parallel with the keyword component, generates another list of advertisements based on targeting data provided by the advertisers. The merging component combines the list of advertisements generated by the keyword component and targeting component based on relevance to user search terms received by the advertisement management system or revenue that the advertisement is able to generate for the advertiser, publisher, or advertisement management system.

### BACKGROUND

Conventionally, a user enters a search query in a web browser executing on a user's computer. The search query represents a search intent for the user. The search query entered into the web browser is sent to a search engine. Advertisers bid on the search query to have their advertisements included in a search results page that is transmitted from the search engine to the user's computer.

Some advertisers may choose to target delivery of the advertisement to users based on gender, time of day, or location. Advertisers that have bid the highest will have optimal placement of their advertisements on the search results page that the search engine sends to the user's web browser. For example, Jim's Pizza may be an advertiser in “Bellevue, Washington” that only wants to show its advertisements to users who are searching for local information around Bellevue. When a user submits a search query in the web browser for “Bellevue, Washington” to the search engine, a results page that includes the advertisement for Jim's Pizza may be returned to the web browser. If Jim's Pizza was the highest bidding advertiser, the advertisement for Jim's Pizza would receive optimal placement. If Jim's Pizza was not the highest bidding advertiser, the advertisement for Jim's Pizza would receive sub-optimal placement.

In some situations, targeting will be ineffective because the search query generated by the user may consist of keywords that have not been bid on by an advertiser. Additionally, targeting will be ineffective when the advertiser is unable to express a type for users that are included in the intended audience for the advertisement. Thus, targeting might fail because the advertiser was unable to effectively select a set of keywords that a user, who is a potential consumer, will submit to the search engine or the advertiser is unable to locate the potential consumer using only keywords.

### SUMMARY

Embodiments of the invention include computer-readable media, methods, and advertisement management systems that manage and select advertisements that are presented to a user.

An advertisement management system is configured to execute a method to manage advertisements. Advertisers may transmit targeting data to the advertisement management system. The targeting data may be associated with one or more categories. Additionally, the advertisers may transmit keywords to the advertisement management system. In turn, the advertisement management system generates parameters for each category associated with the advertiser targeting data or advertiser keywords. The advertisers also transmit bids for each keyword to the advertisement management system. The advertisers are presented with an opt-in selection by the advertisement management system. The opt-in selection allows the advertisers to provide alternate bids via the parameters associated with the categories identified for the advertiser targeting data or advertiser keywords.

This Summary is provided to introduce a selection of concepts in a simplified form that are further described below in the Detailed Description. This Summary is not intended to identify key features or essential features of the claimed subject matter, nor is it intended to be used as an aid in isolation in determining the scope of the claimed subject matter.

### BRIEF DESCRIPTION OF THE DRAWINGS

FIG. 1 illustrates an exemplary computing environment for managing and selecting advertisements, according to embodiments of the invention;

FIG. 2 illustrates an exemplary advertisement management system according to embodiments of the invention;

FIG. 3 illustrates an exemplary advertisement selection data structure, according to embodiments of the invention;

FIG. 4 illustrates an exemplary method that selects advertisements to present to users, according to embodiments of the invention; and

FIG. 5 illustrates an exemplary method that manages advertisements provided by the advertisers, according to embodiments of the invention.

### DETAILED DESCRIPTION

This patent describes the subject matter for patenting with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described. Further, embodiments are described in detail below with reference to the attached drawing figures, which are incorporated in their entirety by reference herein.

As utilized herein, the term “component” refers to any combination of hardware, software, or firmware. Also, as utilized herein, the term “publisher” refers to at least one server computer that provides a graphical user interface to receive search terms via at least one user interface element. Moreover, as utilized herein, the term “category” refers to a class of products or users associated with structured metadata (e.g. parameters) that are used for selection of advertisements.

Embodiments of the invention provide an advertisement management system that manages advertisements that an advertiser is promoting to a group of users. The advertisement management system receives keywords and targeting data to effectively promote the advertisements. The advertisement management system performs multi-parameter matches with metadata or search terms provided by publishers and targeting parameters received from the advertisers. Alternatively, the advertisement management system may perform multi-parameter matches with a combination of the metadata and the search terms provided by the publishers and targeting parameters received from the advertisers. The advertisement management system may send one or more users in the group of users a set of advertisements that includes keyword based advertisements and category based advertisements. In some embodiments, when selecting the set of advertisements, the advertisement management system balances the need to deliver the best advertisement to the group of users, the need to generate the highest revenue for the publisher, and the need to generate the largest return for the advertiser based on bids received from the advertiser that express the type of users that interest the advertiser.

The metadata provided by the publisher provides contextual information to the advertisement management system. Because user intent is not always clear from search terms provided in the search query, the metadata may be formatted into a string that is associated with the search term that is delivered to the advertisement management system. For instance, a publisher may provide the group of users a search box for stock quotes. The group of users may provide ticker symbols in the search box to obtain information on the corresponding stock. If these search terms that include the ticker symbols are sent to the advertisement management system without appropriate formatting, the advertisement management system may select an inappropriate set of advertisements for delivery to the publisher. For instance, “MS” is the stock ticker for Morgan Stanley™, but it is also a common acronym for Microsoft™ and multiple sclerosis. If the advertisement management system does not receive the appropriate formatting an inappropriate set of advertisements is selected for delivery to the publisher. But if the publisher formats the search terms to append the word “stock” to the ticker symbols entered by the group users, the advertisement management system is more likely to return appropriate advertisements to the user.

A computer system for managing and selecting advertisements includes client devices communicatively connected to a publisher, e.g., search engine, and advertisement management system. The client devices generate search terms provided by users of the client devices and transmit the search terms to the publisher. The publisher receives the user search terms and communicates with an advertisement management system to receive previously published advertisements that match the search terms.

As one skilled in the art will appreciate, the computer system includes hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory components can store data momentarily, temporarily, or permanently.

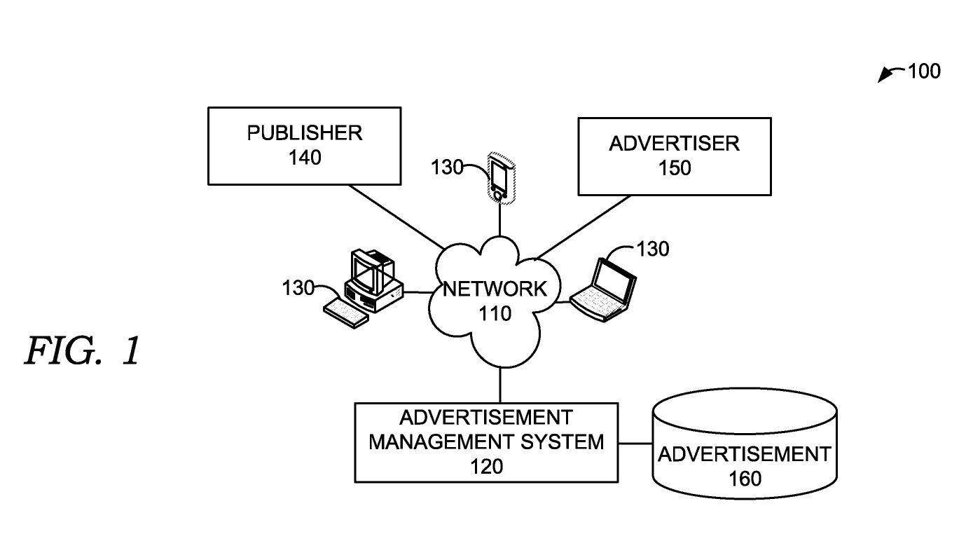

FIG. 1 illustrates an exemplary computing environment for managing and selecting advertisements, according to embodiments of the invention. The computing environment 100 includes a network 110, an advertisement management system 120, client devices 130, a publisher 140, an advertiser 150, and an advertisement database 160.

The network 110 is configured to facilitate communication between the client devices 130 and the publisher 140. The network 110 also facilitates communication between the advertisement management system 120 and the advertiser 150. The network 110 also facilitates communication between the advertisement management system 120 and the publisher 140. The network 110 may be a communication network, such as a wireless network, local area network, wired network, or the Internet. In an embodiment, the client devices 130 communicate search terms to the publisher 140 utilizing the network 110. In response, the publisher 140 provides results that include advertisements that match the search terms, where a subset of the advertisements were targeted by the advertiser to a user of the client devices 130.

The advertisement management system 120 generates advertisements that are transmitted via network 110 to the publisher 140. In turn, the publisher 140 generates a search result page that includes the advertisements. The publisher 140 transmits the search results page to client devices 130, which display the advertisements to the user. In certain embodiments, the advertisement platform 150 interfaces with the publisher 140 to receive the search terms provided by the user. The advertisement management system 120 may require the publisher 140 to format the search terms to include parameters that provide context for the search terms. The advertisement management system 120 also interfaces with the advertisers 150 to allow the advertiser to submit advertisements to the advertisement management system 120. The advertisers 150 provide the advertisement management system 120 with keywords, targeting data, and bids that correspond to the keywords and targeting data. In some embodiments, the targeting data corresponds to the parameters that the advertisement management system requires from the publisher. The parameters are associated with categories, where the advertisement management system 120 allows the advertisers to provide alternative maximum bids for parameters that match a search term provided by a user to the publisher 140. The advertisement management system processes the information provided by the publishers 140 and advertisers 150 to select a set of appropriate advertisements to transmit to the publisher 140.

The client devices 130 are utilized by a user to generate search terms and to receive results having advertisements that are relevant to the search terms. The client devices 130 include, without limitation, personal digital assistants, smart phones, laptops, personal computers, or any other suitable client computing device. The client devices 130 include a user and system information storage to store user and system information on the client device. The user information may include search histories, cookies, and passwords. The system information may include internet protocol address, cached Web pages, and system utilization. In some embodiments, the client device 130 transmits search terms to the publisher 140. In turn, the publisher 140 transmits results that include advertisements to the client device 130.

The publisher 140 responds to search terms received from the client devices 130. The publisher 140 is communicatively connected to the advertisement management system 120 that requires the publisher 140 to format search terms that are communicated to the advertisement management system 120. The publisher 140 returns, to the client devices 130, the advertisements related to the search terms received from the users. In some embodiments, the publisher 140 may provide a listing of web pages matching the search terms received from the user along with the related advertisements.

The advertiser 150 provides targeting data, keywords, bids for keywords, bids for targeting data, and advertisements to the advertisement management system 120. The advertiser 150 promotes goods or services with the advertisements. In some embodiments, the advertiser 150 may opt-in to parameter targeting provided by the advertisement management system 120. The parameter targeting allows the advertiser 150 to vary a maximum bid for search terms received by the advertising management system 120.

The advertisement database 160 stores advertisements. The advertisement database 160 is created based on the advertisement received from the advertiser 150. The advertisement database 160 also stores the keywords, targeting data, and bids associated with each advertisement. In some embodiments, the advertisements are banner advertisements, display advertisements, text, images, contextual advertisements, search advertisements, audio advertisements, or mobile advertisements that describe a good, service or thing that an advertiser wishes to promote to users. The things described in the advertisements may include events and items from all over the world, from various merchants, and from various distributors. The advertisements are selected by the advertisement management system 120 and transmitted in response to search terms received from the publisher 140.

Accordingly, the computing environment 100 is configured with a publisher 140 that provides advertisements to a user based on advertisements selected by the advertisement management system 120. The advertisement management system 120 traverses the advertisement database 160 based on the search terms received from the publisher 140. In turn, the advertisement management system 120 generates a ranked set of advertisements that is returned to the publisher 140.

One of ordinary skill in the art understands and appreciates the computing environment 100 has been simplified for description purposes and alternate operating environments are within the scope and spirit of this description.

In certain embodiments, an advertisement management system receives search terms from a publisher. The advertisement management system processes the search terms to identify a set of advertisements that match the search terms. In an embodiment, the advertisement management system executes a keyword component and targeting component to identify the set of advertisements. The advertisement management system selects the advertisements by traversing an advertisement database to locate each advertisement in the set of advertisements.

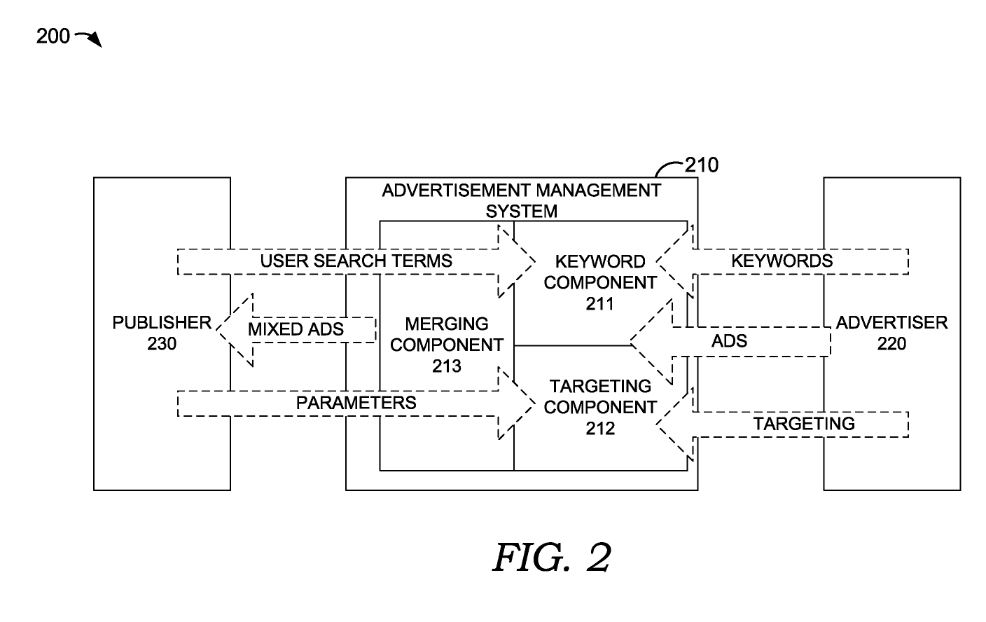

FIG. 2 illustrates an exemplary advertisement management system 210 according to embodiments of the invention. The advertisement platform 200 includes an advertisement management system 210, advertisers 220, and publishers 230. In an embodiment, the advertisement platform 200 responds to search terms received at a graphical user interface of a publisher 230 with results that include advertisements that match the search terms. The advertisements included in the result set are selected by the advertisement management system 210.

The advertisement management system 210 receives advertisements from the advertisers 220. The advertisements are stored in an advertisement database. The advertisement management system 210 includes a keyword component 211, a targeting component 212, and a merging component 213. The keyword component 211 and targeting component 212 generate a list of advertisements that match search terms and parameters associated with the search terms provided by the publisher. The merging component 213 combines the lists generated by the keyword component 211 and the targeting component 212. The advertisement management system 210 selects and ranks a subset of the advertisements included in a merged list. The subset of the advertisements are transmitted from the advertisement management system 210 to the publisher 230. The publisher 230 receives the advertisements and transmits the advertisements and results to a client device for display to a user. In some embodiments, the keyword component 211 and targeting component 212 execute in parallel.

The keyword component 211 receives keywords from the advertisers 220. In an embodiment, the keywords provided by the advertiser 220 allow broad matching the results in imprecise matching with the search terms received from the publishers 230. The keywords represent the words that the advertiser 220 selects to have the advertisement management system 210 trigger potential selection of the advertisement provided by the advertiser 220. Also, the keyword component 211 receives search terms that a user provides to the publisher 230. The keyword component 211 parses the search terms and matches the search terms with the keywords provided by the advertiser 220. When a match occurs, the advertisement corresponding to the keyword is added to a list. In an embodiment, the advertisements in the list are ranked based on, among other things, advertiser bid amount, user click probability, and a score that represents the relevance and quality of the advertisement to the search terms. The list of advertisements is sent to the merging component 213 to combine with a list of advertisements generated by the targeting component 212.

The targeting component 212 receives targeting data from the advertisers 220. The advertiser 220 chooses to opt-in to targeting users with advertisements. The targeting component 212 allows the advertisers 220 to bid on a selected number of parameters in addition to keywords. Also, the advertisers 220 are able to specify wildcards, e.g. “?” or “*,” for particular parameters. Moreover, in certain embodiments, the advertiser 220 may select some of the parameters as required parameters and other parameters as optional parameters.

In some embodiment, the targeting data corresponds to parameters associated with one or more categories—including, but not limited to, hotels, car rentals, airline ticket purchases, stock, real estate—that interest an advertiser 220. A publisher 230 that specializes in one or more of the categories is required to provide the targeting component 212 with a selected number of parameters requested by the targeting component 212 of the advertisement management system 210. In one embodiment, the publisher 230 may format the search terms to include values for the selected number of parameters in a string that is associated with the search terms. In an alternate embodiment, the publisher 230 may provide the values for the selected number of parameters after the targeting component 212 requests the publisher 230 for the values for the selected number of parameters.

The targeting component 212 may generate a request for targeting data using the following request format: targeting={category}|{parameter 1}|{parameter 2}|{parameter n}. The number of parameters for the category varies based on importance to the user, advertiser 220, or publisher 230. In some embodiments, the advertisement management system may pre-define a format for each category. The targeting component 212 may allow the advertiser 220 to opt-in to targeting for, among other categories, television, hotel, flight, stock, loan, real estate, and gaming. The formatted search terms, or a response from the publisher 230 to a request for the parameters, may take the following format. In some embodiments, the publisher is a comparison shopping web site, e.g. e-bay.com, amazon.com, and msnshopping.com, that provided fields to receive values for each of the parameters associated with category. In the television category, where screen size and technology are parameters, the formatted search terms or a response from the publisher 230 may include targeting=tv|{screen size (52′)}|{technology (LCD)}. In the hotel category, where city, check-in, and check-out are parameters, the formatted search terms or a response from the publisher 230 may include targeting=hotel|{city (Las Vegas)}|{check-in (May. 15, 2008)}|{check-out (May 20, 2008)}. In the flight category, where departure city, arrival city, departure date, and return date are parameters, the formatted search terms or a response from the publisher 230 may include targeting=flight|{departure city (Seattle)}|{destination city (Las Vegas)}|{departure date (May 15, 2008)}|{return date (May 18, 2008)}. In the stock category, where stock symbol is a parameter, the formatted search terms or a response from the publisher 230 may include targeting=stock|{symbol (MSFT)}. In the loan category, where loan type and loan amount are parameters, the formatted search terms or a response from the publisher 230 may include targeting=loan|{loan type (student loan)}|{loan amount (30000)}. In the real estate category, where zip code, minimum price, and maximum price are parameters, the formatted search terms or a response from the publisher 230 may include targeting=real estate|{zip code (98007)}|{min. price (150,000)}|{max. price (250,000)}. In the gaming category, where platform and type are parameters, the formatted search terms or a response from the publisher 230 may include targeting=gaming|{platform (xbox360)}|{type (software)}. Accordingly, the advertisement management system does not require a publisher to maintain user information. Moreover, the advertisements selected by the advertisement management system are close matches for the user and advertiser.

In another embodiment, the values for the parameters are provided to the targeting component 212 by a third-party entity, such as an email server, an instant messaging server, a social networking server, or a banking server that is separate from the publisher 230. The targeting component 212 may request values for parameters associated with behavioral, demographic, or social values for a user that generated the search term from the third-party entity. The targeting component 212 may allow the advertiser to opt-in to targeting for, among other categories, demographic, social, annual bonus, emotion, and behavior. The response from the third-party entity to a request for the parameters may take the following format. In the demographic category, where country, zip code, age, and gender are parameters, the response from the third-party entity may include targeting=demographic|{country (US)}|{zip code (98007)}|{age (23)}|{gender (M)}. In the social category, where school, employer, number of friends, and marital status are parameters, the response from the third-party entity may include targeting=social|{school (Stanford)}|{employer (Microsoft)}|{number of friends (243)}|{marital status (single)}. In the annual bonus category, where employer and month of bonus are parameters, the response from the third-party entity may include targeting=annual bonus|{employer (Microsoft)}|{month of annual bonus (Sep)}. In the emotion category, where present feeling and reason are parameters, the response from the third-party entity may include targeting=emotion|{present feeling (sad)}|{treason (divorce)}. In the behavior category, where website, user identifier, and visit frequency are parameters, the response from the third-party entity may include targeting=behavior|{website (ayah.com)}|{user identifier (mxc)}|{frequency (3 visits per day)}.

In another embodiment, the values for the parameters are provided to the targeting component 212 by a crawler that is separate from the publisher 230. The crawler crawls the publisher website to locate the values for the parameters requested by the targeting component. The crawler provides the targeting component 212 with the values for the requested parameters.

Because the targeting component 212 allows the advertiser 220 specify a bid for each parameter in any of the categories, the advertiser 220 may vary the bid amount based on importance of the parameter to the advertiser 220. For instance, an advertiser 220 that opts-in to targeting may select the hotel category. The targeting component 212 generates the fields for the advertiser to specify whether the parameters are optional and the bid amount that corresponds to parameters. The advertiser 220 would receive fields for city of the hotel location, check-in date, and check-out date. The advertiser 220 may select New York as the city. Also, the advertiser 220 may indicate that the city as New York is a required parameter. The advertiser 220 may select check-in and check-out as optional parameters. Also, the advertiser 220 may use the wild card to allow variable matches. For instance, the advertiser may specify any day in August with “8-?-2009” for dates. Moreover, the advertiser 220 may set multiple maximum bids. The maximum bid for a match in city parameter may be set at $1.00 by the advertiser 220. The maximum bid for a match in the city and check-in parameters, may be set at $1.50 by the advertiser. The maximum bid for a match in the city, check-in, and check-out parameters, may be set at $2.00 by the advertiser 220. In another embodiment, the maximum bid is determined based on differential bids received from the advertiser for each parameter associated with a category. The advertisement management system may modify the maximum bid depending on the number of matching parameters. The bid associated with each matching parameter is summed to arrive at the maximum bid for the corresponding matches.

In certain embodiments, the targeting component 212 generates a list of advertisements that match the values received for the publisher 230 or the third-party entity based on parameters designated as required. In turn, the maximum bid may be determined based on the number of optional parameters that match the values received for the publisher 230 or the third-party. In some embodiments, the advertisements in the list are ranked based on, among other things, advertiser bid amount, user click probability, and a score that represents the relevance of the advertisement to the search terms. The list of advertisements is sent to the merging component 213 to combine with a list of advertisements generated by the keyword component 211.

The merging component 213 receives the lists from the keyword component 211 and the targeting component 212. Also, the merging component 213 extracts a number of advertisements requested by the publisher 230 specified in the formatted search terms or in a response from the publisher 230 to a request from the advertisement management system 210. The merging component combines the advertisements in the lists and uses the rank assigned to each advertisement to generate a combined list of advertisements in order of decreasing rank. The merging component transmits the number of requested advertisements to the publisher 230. The advertisements transmitted to the publisher 230 are the advertisements that have the highest rank. In some embodiment, the merging component 213 generates a combined list based on maximum revenue or maximum relevance or the combination or maximum revenue and maximum relevance corresponding to each advertisement in the lists. Without the merging component 213, a publisher is less likely to opt-in to the parameter targeting provided by the advertisement management system 210. With the merging component, the advertisement management system 210 may guarantee a return on investment equal to an amount of money that the advertiser or publisher usually makes when using only keywords. Accordingly, in some embodiments, the advertisements associated with parameter targeting are presented to the user if the advertisements provide a higher return on investment for the advertiser or publisher.

The maximum bid that the advertiser 220 sets for the advertisements may vary depending on the advertiser's keywords, the advertiser's selected number of parameters, matches with the formatted search terms, and matches with values provided by the publisher 230, a third party entity, or a crawler. With an appropriate maximum bid selected for each advertiser, the advertisement management system 210 selects a set of advertisements that are transmitted to publisher 230.

The publisher 230 receives the set of advertisements. In some embodiments, the advertisements are dynamically formatted. The advertisement management system 210 may execute scripts included with the selected advertisements when generating a combined list that includes the advertisement. The scripts may use exact values or proximate values that were received from the publisher 230, the third party entity, or the crawler, to dynamically generate the content for a corresponding advertisement. For instance, a dynamic loan advertisement may include an advertisement title: “Looking for <loan type>?”; and an advertisement description: “0% interest for loans less than <if loan amount<$100,001, show loan amount; else show $100,000> at advertiser.com” Thus, the publisher 230 that receives a search for a $100,000 student loan may receive an advertisement from the advertisement management system 210 that is modified by the script. When the advertisement management system 210 executes the script, the advertisement management system 210 may dynamically change the advertisement title to: “Looking for a student loan?,” and change the advertisement description to: “0% interest rate for loans less than $100,000 at advertiser.com.” The advertisement management system 210 selected the advertisement and dynamically modified the advertisement to result in a closer match to the search received from the publisher 230.

In some embodiments, an advertisement management system uses a data structure to organize the list of matching advertisements received from a keyword component and a targeting component. The data structure includes a matching advertisements segment that stores a matching advertisement. Each matching advertisement segment include bid attributes that represent the various maximum bids that corresponds to the matching advertisement. Each advertisement matching advertisement segment also includes an address field (e.g., binary) that identifies which of the various maximum bids is the maximum bid.

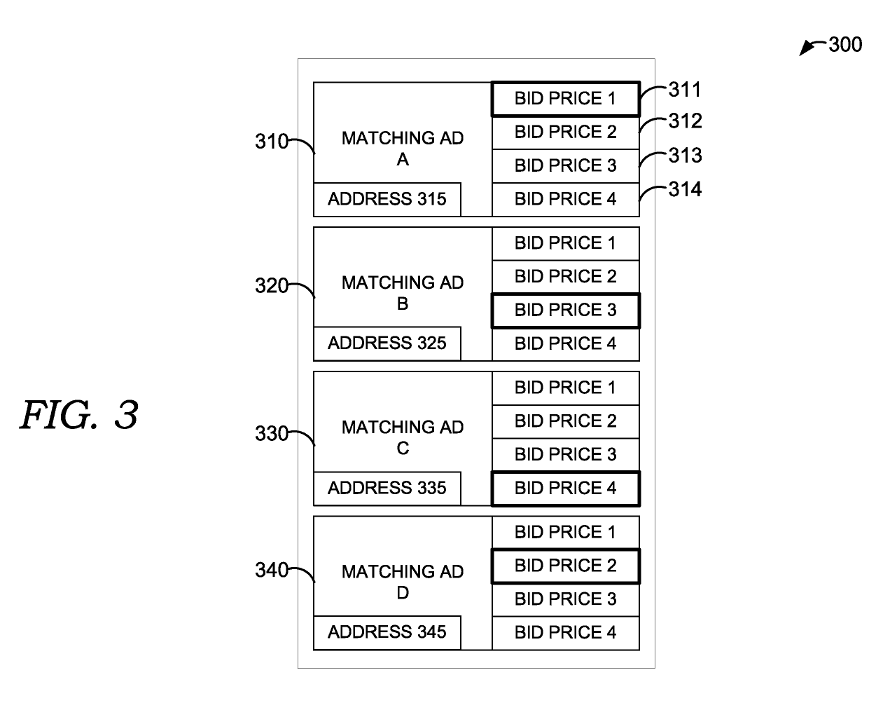

FIG. 3 illustrates an exemplary advertisement selection data structure 310, according to embodiments of the invention. The advertisement selection data structure includes matching advertisements segments 310, 320, 330, and 340. Each matching advertisement is stored in the matching advertisement segment 310. The attributes 311-314 for the matching advertisement segment 310 specifies potential maximum bids for the matching advertisement. Also, the matching advertisement segments 310, 320, 330, and 340 include an address field 315, 325, 335, and 345, for address information that specifies the location, e.g., 311, 312, 313, or 314, of the maximum bid identified by the advertisement management system. The advertisement selection data structure 310 allows the advertisement management system to efficiently select the matching advertisements having the highest maximum bid.

In another embodiment, an advertisement management system selects advertisements based on matches with formatted search terms and values for parameters requested by the advertisement management system. The matching advertisements with the highest maximum bid, highest probability of user click, and highest relevance score are selected and transmitted to present to users that provided search terms to the publisher. The publisher presents the advertisements, which may be dynamically configured based on a subset of the values associated with the parameters requested by the advertisement management system. The appropriate maximum bid and relevance scores are calculated after the advertisement is dynamically configured based on the received value for the requested parameters.

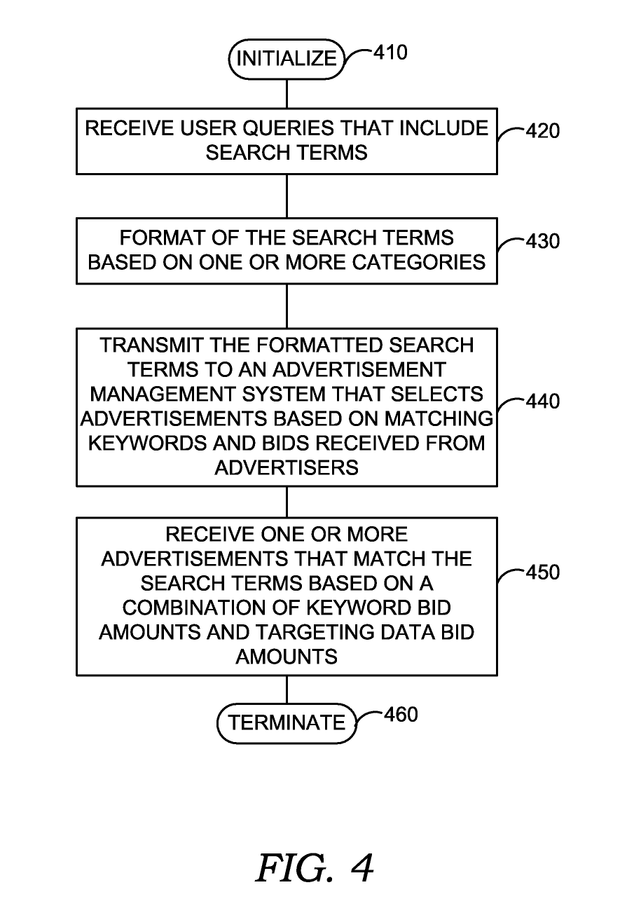

FIG. 4 illustrates an exemplary method that selects advertisements to present to users, according to embodiments of the invention. The advertisement management system includes one or more computer-readable media storing instructions that configure a processor to perform a method to select advertisements. The method to select advertisements is initialized at step 410, when the advertisement management system is powered on. At step 420, a publisher receives user queries that include search terms. In some embodiments, the publisher is one of a search engine server, an email server, a social networking server, or an online purchasing server. The search terms received from a user are formatted to include a string based on one or more categories corresponding to a subset of the search terms in step 430.

The publisher formats the search terms by identifying parameters associated with the one or more categories. In some embodiments, the identified parameters are requested by the advertisement management system. In turn, the parameters and corresponding values are linked with the subset of search terms. The publisher may also link user identifiers with search terms. The publisher may link a threshold number of advertisements that the advertisement management systems should return to the publisher with the search terms.

In step 440, the formatted search terms are transmitted from the publisher to the advertisement management system. The advertisement management system selects advertisements that correspond to the search terms provided by the user based on matching keywords with the formatted search terms and bids received from advertisers. In certain embodiments, the advertisement management system also selects advertisements that correspond to the search terms provided by the user based on matching categories with attributes of the formatted search terms and the various bids received from advertisers. At step 450, the publisher receives one or more advertisements that match the search terms, where the advertisements are selected from a merged set of ranked advertisements based on a combination of keyword bid amounts and targeting data bid amounts. The bids may correspond to keywords and targeting data associated with the one or more categories. In certain embodiments, the at least one advertisement is the advertisement having the largest bid amount when compared to a bid amount of the other advertisements in a merged set of ranked advertisements. In turn, the publisher generates for display a message that includes at least one of the advertisements included in the merged set of ranked advertisements. The method terminates in step 460.

In another embodiment, an advertisement management system manages advertisements based on keywords and targeting data received from advertisers. The advertisement management system generates parameters associated with the targeting data. In turn, the advertiser bids on the keyword and parameters. The advertisement management system uses the bids on the keywords and parameters to rank advertisements that match search terms received by the advertisement management system.

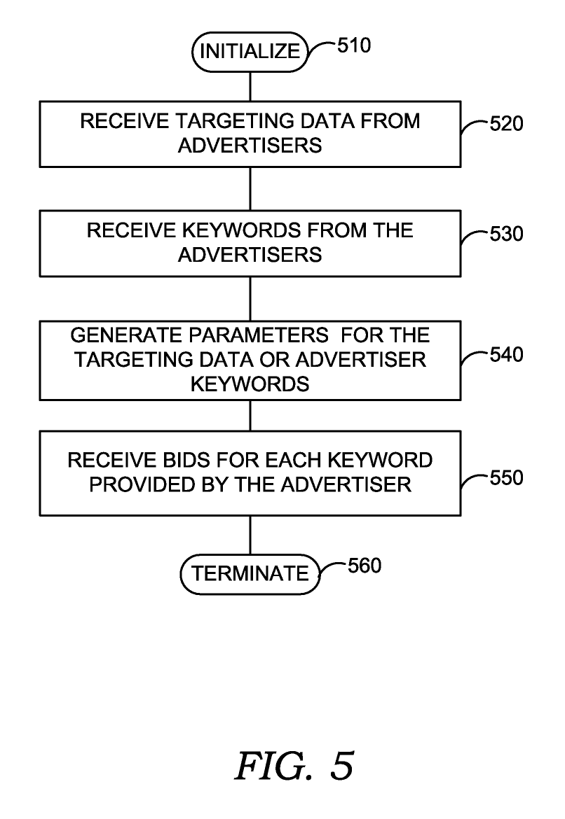

FIG. 5 illustrates an exemplary method that manages advertisements provided by the advertisers, according to embodiments of the invention. The advertisement management system executes a method to manage advertisements. The method initializes in step 510 when the advertisement management system is powered on. The advertisement management system receives targeting data from advertisers, in step 520. The advertiser targeting data may represent one or more markets that the advertisers plan to reach with the advertisements. In some embodiments, the targeting data is associated with one or more categories.

The categories may include at least one of the following: televisions, hotels, flights, stocks, loans, real estate, games, demographic, behavior, and social. In turn, the advertisement management system receives keywords from the advertisers, in step 530. Queries received by the advertisement management system from users are parsed to identify queries that include the keywords. In step 540, the advertisement management system generates parameters for each category associated with the advertiser targeting data or advertiser keywords. The parameters may include mandatory parameters and optional parameters. In some embodiments, the parameters for each category associated with the one or more categories are transmitted to publishers.

In step 550, the advertisers transmit bids for each keyword to the advertisement management system. In some embodiments, the advertisement management system provides advertisers with an opt-in selection. The opt-in selection allows the advertisers to provide alternate bids via the parameters associated with the categories identified for the advertiser targeting data or advertiser keywords. The alternate bids on the parameters may be used to determine which advertiser's advertisement is selected for display. In an embodiment the alternate bids allows the advertiser to value the importance of each parameter. For instance, a base bid of $1.00 may be associated with the category, flight, and differential bids are associated with each parameter, e.g. departure date: +$0.30, return date: +$0.30, and cabin class: +$1.00. The method terminates in step 560.

In summary, computer-implemented methods, computer-readable media, and advertisement management systems that manage and select advertisements are provided. The advertisement management system is configured to perform multi-parameter matches, to deliver the best advertisements to the user, to generate the highest revenue or the most relevant advertisement for the publisher, and to provide the largest return for the advertiser. The advertisement management system requires values for meaningful parameters for a number of categories. The parameters are transparently visible to the advertisers, who may vary the maximum bid for advertisements that target the users. The advertisement management system attempts to provide an easy migration from advertisement delivery based only on keyword to a higher yielding advertisement delivery based on a hybrid of keyword and parameter targeting.

The foregoing descriptions of the embodiments of the invention are illustrative, and modifications in configuration and implementation will occur to persons skilled in the art. For instance, while the embodiments of the invention have generally been described with relation to FIGS. 1-5, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the embodiments of the invention are accordingly intended to be limited only by the following claims.

We claim:

1. In an advertisement management system executing a method to manage advertisements, the method comprising:
receiving targeting data from advertisers, wherein the targeting data is associated with one or more categories;
receiving keywords from the advertisers;
generating parameters for each category associated with the advertiser targeting data or advertiser keywords;
receiving bids for each keyword provided by the advertiser; and
providing advertisers with an opt-in selection, which allows the advertisers to provide alternate bids via the parameters associated with the categories identified for the advertiser targeting data or advertiser keywords.

2. The computer-implemented method of claim 1, further comprising parsing queries received by the advertisement system from users to identify queries that include the keywords.

3. The computer-implemented method of claim 1, wherein the advertiser targeting data represents one or more markets that the advertisers plan to reach with the advertisements.

4. The computer-implemented method of claim 1, wherein the parameters include mandatory parameters and optional parameters.

5. The computer-implemented method of claim 4, wherein bids on the parameters are used to determine which advertiser's advertisement is selected for display.

6. The computer-implemented method of claim 1, further comprising transmitting parameters for each category associated with the one or more categories to publishers.

7. The computer-implemented method of claim 1, wherein the categories are at least one of the following: televisions, hotels, flights, stocks, loans, real estate, games, demographic, behavior, and social.

8. An advertisement management system, the advertisement management system comprising:
a keyword component configured to receive advertiser keywords and associated advertisements from an advertiser and to generate a list of advertisements that includes the advertisements associated with a keyword that matches search terms received from a user;
a targeting component configured to receive advertiser targeting data and associated advertisements from the advertisers and to generate a list of advertisements that includes the advertisements associated with targeting data that matches parameters included in the search terms received from the user; and
a merging component configured to merge advertisements in the lists generated by the keyword component and targeting component, wherein merging the advertisements comprises sorting the advertisement based on a score assigned to each advertisement to maximizes relevance or revenue.

9. The advertisement management system of claim 8, wherein the score is the product of maximum bid for matching parameters or keywords, an observed probability of a user clicking on a displayed advertisement, and the relevance score of the advertisement to the search terms provided by the user.

10. The advertisement management system of claim 8, wherein the keywords or targeting data include wildcards.

11. The advertisement management system of claim 8, wherein the keyword component and targeting component execute in parallel to generate the lists.

12. The advertisement management system of claim 8, wherein a set of merged advertisements is transmitted to publishers providing an interface to allow the user to generate the search terms.

13. The advertisement management system of claim 12, wherein the set of advertisements is returned based on a number of advertisements that each publisher requests.

14. One or more computer-readable media storing instructions to execute a method to select advertisements, the method comprising:
receiving, at a publisher, user queries that include search terms;
formatting of the search terms received from a user based on one or more categories corresponding to a subset of the search terms;
transmitting the formatted search terms from the publisher to an advertisement management system that selects advertisements that correspond to the search terms provided by the user based on matching keywords with the formatted search terms and bids received from advertisers;
receiving, at the publisher, one or more advertisements that match the search terms, wherein the advertisements are selected from a merged set of ranked advertisements based on a combination of keyword bid amounts and targeting data bid amounts; and
generating for display a message that includes at least one of the advertisements included in the merged set of ranked advertisements.

15. The computer-readable media of claim 14, wherein formatting of the search terms received from a user based on the one or more categories corresponding to a subset of the search terms further comprises:
identifying parameters associated with the one or more categories; and
linking the parameters with the subset of search terms.

16. The computer-readable media of claim 15, wherein the at least one advertisement is the advertisement having a larger bid amount or higher relevance score when compared to a bid amount or relevance score of the other advertisements in a merged set of ranked advertisements.

17. The computer-readable media of claim 16, wherein the bids correspond to keywords and targeting data associated with the one or more categories.

18. The computer-readable media of claim 17, wherein the publisher provides a user identifier along with the formatted search term to the advertisement management system.

19. The computer-readable media of claim 18, wherein the publisher comprises one of: a search engine server, an email server, a social networking server, and an online purchasing server.

20. The computer-readable media of claim 19, wherein the formatted search terms specifies a threshold number of advertisements that the advertisement management systems should return to the publisher.
